(19) United States
(12) Patent Application Publication
(10) Pub. No.: US 2017/0091117 A1
(43) Pub. Date: Mar. 30, 2017

(54) METHOD AND APPARATUS FOR CACHE LINE DEDUPLICATION VIA DATA MATCHING

(71) Applicant: QUALCOMM Incorporated, San Diego, CA (US)

(72) Inventors: Harold Wade CAIN, III, Raleigh, NC (US); Derek Robert HOWER, Durham, NC (US); Raguram DAMODARAN, San Diego, CA (US); Thomas Andrew SARTORIUS, Raleigh, NC (US)

(21) Appl. No.: 14/865,049

(22) Filed: Sep. 25, 2015

(51) Int. Cl. G06F 12/12; G06F 12/08

(52) U.S. Cl. CPC G06F 12/121; G06F 12/0808; G06F 12/0815; G06F 2212/69; G06F 2212/621

(57) ABSTRACT

A cache fill line is received, including an index, a thread identifier, and cache fill line data. The cache is probed, using the index and a different thread identifier, for a potential duplicate cache line. The potential duplicate cache line includes cache line data and the different thread identifier. Upon the cache fill line data matching the cache line data, duplication is identified. The potential duplicate cache line is set as a shared resident cache line, and the thread share permission tag is set to a permission state.

### TECHNICAL FIELD

The present application relates generally to cache and cache management.

### BACKGROUND

Cache is a fast access processor memory that stores copies of particular blocks of memory, for example, recently used data or instructions. This can avoid overhead and delay of fetching data and instructions from main memory.

Cache content can be arranged and accessed as blocks, generally termed “cache lines.”

The greater the cache capacity, i.e., greater the number of cache lines, the greater the probability that a cache read will produce a “hit” instead of a “miss.” A low miss rate is typically desired because misses can interrupt and delay processing. The delay can be substantial because the processor must search the slower main memory, find and retrieve the desired content, and then load that content into the cache. Cache capacity, though, can carry substantial costs in power consumption and chip area. Reasons include cache speed requirements, which can necessitate higher area/higher power memory. Cache capacity can therefore be a compromise between performance and power/area cost.

Processors often run multiple threads concurrently, and each of the threads may access the cache. A result can be competition for cache space. As illustration, if multiple threads access, for example, a direct mapped cache using the same virtual address index, a result can be each cache line load removing or flushing any existing cache line in the cache slot to which the virtual index maps. In various techniques that use the thread identifier as a tag, duplicate cache lines can be created, identical to one another except for different thread identified tags.

### SUMMARY

This Summary identifies features and aspects of some example aspects, and is not an exclusive or exhaustive description of the disclosed subject matter. Whether features or aspects are included in, or omitted from this Summary is not intended as indicative of relative importance of such features. Additional features and aspects are described, and will become apparent to persons skilled in the art upon reading the following detailed description and viewing the drawings that form a part thereof.

Various methods for de-duplicating a cache is disclosed and, according to various exemplary aspects, example combinations of operations can include receiving a cache fill line, including an index, cache fill line data, and tagged with a first thread identifier, probing a cache address, the cache address corresponding to the index, using a second thread identifier, for a potential duplicate resident cache line, including resident cache line data and tagged with the second thread identifier. In aspect, example operations can also include, based at least in part on a match of the cache fill line data to the resident cache line data, determining a duplication and, in response, assigning the potential duplicate resident cache line as a shared resident cache line and setting a thread share permission tag of the shared resident cache line to a permission state, the permission state being configured to indicate a first thread has sharing permission to the shared resident cache line.

Various cache systems are disclosed and, according to various exemplary aspects, example combinations of features can include a cache, configured to retrievably store a plurality of resident cache lines, each at a location corresponding to an index, and each including resident cache line data, and tagged with a resident cache line thread identifier and a thread share permission tag. In an aspect, combinations of features can also comprise a cache line fill buffer, configured to receive a cache fill line, comprising a cache fill line index, a cache fill line thread identifier and cache fill line data, and can include a cache control logic. In an aspect, the cache control logic can be configured to identify, in response to the cache fill line thread identifier being a first thread identifier, a potential duplicate resident cache line among the resident cache lines, tagged with a second thread identifier. In an aspect, the cache control logic can be configured to set the thread share permission tag of the potential duplicate resident shared resident cache line to a permission state, based at least in part on the probe identifying the potential duplicate cache line in combination with the potential duplicate cache line data matching the cache fill line data.

Other systems are disclosed and, according to various exemplary aspects, example combinations of features can include a cache, configured to retrievably store resident cache line, at an address corresponding to an index, the resident cache line, including resident cache line data and tagged with a first thread identifier and a thread share permission tag. In an aspect, example combinations of features can include the thread share permission tag being at a “not shared” state and switchable to at least one permission state. In an aspect, example combinations of features can include a cache line fill buffer, configured to receive a cache fill line, comprising a cache fill line index and cache fill line data, and tagged with a second thread identifier, in communication with a cache control logic. In an aspect, the cache control logic can be configured, according to various combinations of features, to set the thread share permission tag of the shared resident cache line to a permission state, based at least in part on the cache line fill index being a match to the index, in combination with the resident cache line data being a match the cache fill line data.

Apparatuses for de-duplication of a cache are disclosed, and according to various exemplary aspects, example combinations of features can include means for probing a cache address, the cache address corresponding to the index, using a second thread identifier, for a potential duplicate resident cache line, the potential duplicate resident cache line comprising resident cache line data and tagged with the second thread identifier, in combination with means for determining a duplication, based at least in part on a match of the cache fill line data to the resident cache line data, and means for assigning the potential duplicate resident cache line as a shared resident cache line and setting a thread share permission tag of the shared resident cache line to a permission state, upon determining the duplication, the permission state indicating the first thread has sharing permission to the shared resident cache line.

### BRIEF DESCRIPTION OF THE DRAWINGS

The accompanying drawings are presented to aid in the description of example aspects and are provided solely for illustration of the embodiments and not limitation thereof.

FIG. 1 shows a functional block schematic of one example dynamic multi-thread sharing permission tag (“dynamic MTS permission tag”) cache system according to various exemplary aspects.

FIG. 2 shows a flow diagram of example operations in a portion of one dynamic MTS permission tag cache process according to various exemplary aspects.

FIG. 3 shows a logic schematic of portions of an access circuitry of one dynamic MTS permission tag cache according to various exemplary aspects.

FIG. 4 shows a flow diagram of example operations within one dynamic MTS permission tag cache search and permission update according to various exemplary aspects.

FIG. 5 illustrates an exemplary wireless device in which one or more aspects of the disclosure may be advantageously employed.

### DETAILED DESCRIPTION

Aspects and features, and examples of various practices and applications are disclosed in the following description and related drawings. Alternatives to disclosed examples may be devised without departing from the scope of disclosed concepts. Additionally, certain examples are described using, for certain components and operations, known, conventional techniques. Such components and operations will not be described in detail or will be omitted, except where incidental to example features and operations, to avoid to obscuring relevant details.

The word “exemplary” is used herein to mean “serving as an example, instance, or illustration.” Any aspect described herein as “exemplary” is not necessarily to be construed as preferred or advantageous over other aspects. In addition, description of a feature, advantage or mode of operation in relation to an example combination of aspects does not require that all practices according to the combination include the discussed feature, advantage or mode of operation.

The terminology used herein is for the purpose of describing particular examples and is not intended to impose any limit on the scope of the appended claims. As used herein, the singular forms “a”, “an” and “the” are intended to include the plural forms as well, unless the context clearly indicates otherwise. In addition, the terms “comprises”, “comprising,”, “includes” and/or “including”, as used herein, specify the presence of stated features, integers, steps, operations, elements, and/or components, but do not preclude the presence or addition of one or more other features, integers, steps, operations, elements, components, and/or groups thereof.

Further, various exemplary aspects and illustrative implementations having same are described in terms of sequences of actions performed, for example, by elements of a computing device. It will be recognized that such actions described can be performed by specific circuits (e.g., application specific integrated circuits (ASICs)), by program instructions being executed by one or more processors, or by a combination of both. Additionally, such sequence of actions described herein can be considered to be implemented entirely within any form of computer readable storage medium having stored therein a corresponding set of computer instructions that upon execution would cause an associated processor to perform the functionality described herein. Thus, the various aspects of implemented in a number of different forms, all of which are contemplated to be within the scope of the claimed subject matter. In addition, for actions and operations described herein, example forms and implementations may be described as, for example, “logic configured to” perform the described action.

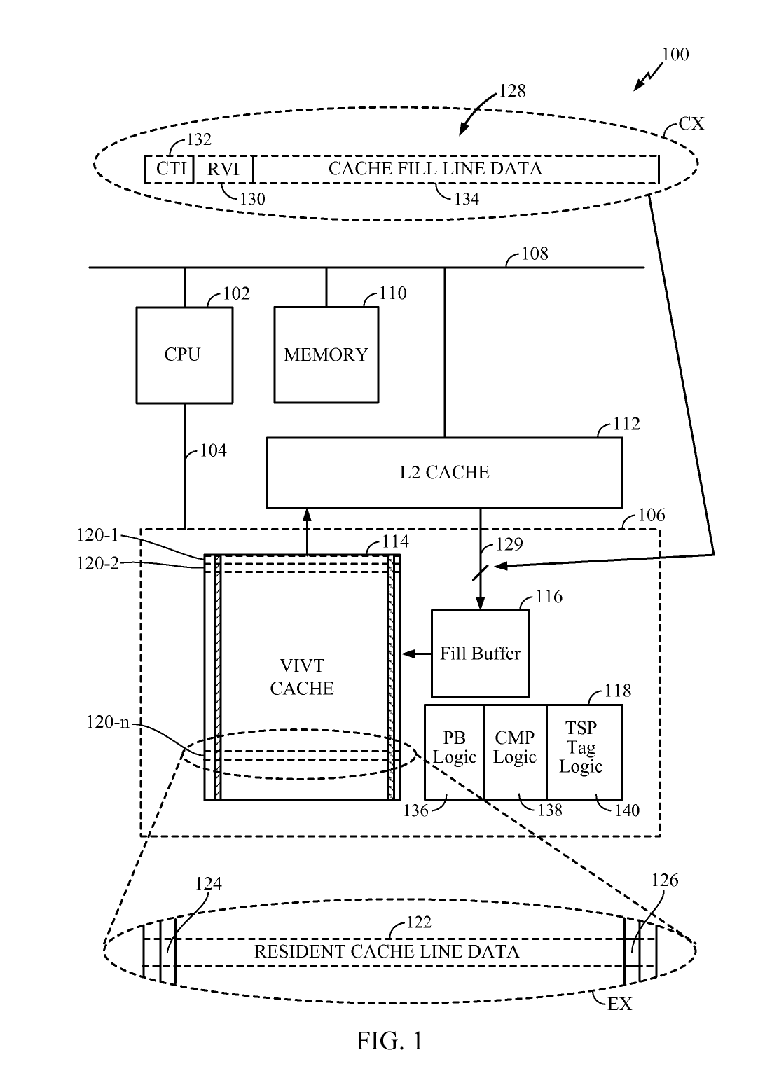

FIG. 1 shows a block schematic of a processor system 100, comprising a central processing unit (CPU) 102 coupled, for example, through a local bus 104 or equivalent, to a cache 106 according to various aspects. The CPU 102 can also be logically interconnected, for example through a processor bus 108, with a processor main memory 110.

Referring to FIG. 1, the cache 106 can be configured with features of dynamic, e.g., run-time, granting of permissions for threads other than the thread that instantiates a cache line, to access that line, as well as features of multiple threads accessing the cache lines in accordance with the granted permissions. For purposes of description, various arrangements and configurations, combinations and sub-combinations of disclosed features of dynamic, e.g., run-time, granting of permissions for threads other than the thread that instantiates a cache line, to access that line, and features of multiple threads accessing the cache lines in accordance with the granted permissions, will be collectively referenced as “dynamic multi-thread sharing permission tag cache,” abbreviated as “dynamic MTS permission tag cache.” In an aspect, the cache 106 can be configured to provide dynamic MTS permission tag cache functionalities in combination with known conventional cache functionalities.

The processor system 100 can be configured with the cache 106 as a lowest level cache of a multi-level cache arrangement (visible but not separately labeled) that includes a second level cache 112. This configuration is only for purposes of example, and is not intended to limit any aspects or features of multi-thread dynamic cache line permission tag sharing of cache lines to disclosed concepts to a lower level cache portion of a two-level cache resource. Instead, as will be appreciated by persons of skill upon reading this disclosure multi-thread dynamic cache line permission tag sharing of cache lines according to disclosed concepts may be practiced, for example, in a single-level cache, or in a second-level cache of a two-level cache system, or in any one or more cache levels of any multi-level cache system.

Referring to FIG. 1, the cache 106 can include a dynamic thread permission tagged cache device 114, a cache fill buffer 116, and a cache control logic 118. In an aspect, the cache fill buffer 116 and cache control logic 118 can be configured, as described in greater detail later, to include multi-thread dynamic cache line permission tag functionality in addition to known, conventional cache fill buffer and cache controller functionalities. The multi-thread cache line sharing functionality of the dynamic thread permission tagged cache device 114 can be implemented in or with caches configured according to various addressing schemes. For example, a virtual index/virtual tag (VIVT) implementation of the dynamic thread permission tagged cache device 114, further to this aspect, are described in greater detail later in this disclosure. Example operations according to various aspects are described herein in reference to VIVT addressing schemes. However, this is not intended to limit the scope of practices according to various disclosed aspects to VIVT caches. On the contrary, persons of skill can adapt disclosed practices to other cache addressing techniques, for example, without limitation, physically indexed, physically tagged or virtually indexed, physically tagged, without undue experimentation.

Referring to FIG. 1, the dynamic thread permission tagged cache device 114 can store a plurality of cache lines, such as the example cache lines 120-1, 120-2 . . . 120-n. For convenience, the cache lines 120-1, 120-2 . . . 120-n will be alternatively referenced as “resident cache lines 120” and, in the generic singular, as “a resident cache line 120” (the label “120” does not explicitly appear in FIG. 1). The resident cache lines 120 can be configured to provide, in various combinations, features of dynamic MTS permission tag functionality according to various aspects, examples of which will be described in greater detail.

Referring to the enlarged view EX, the FIG. 1 resident cache line 120 can include resident cache line data 122 and, as tags, a cache line thread identifier 124 and a thread share permission tag 126. Optionally, the resident caches lines 120 may include an address space identifier (not explicitly visible in FIG. 1), a virtual tag (not explicitly visible in FIG. 1) and mode bits (not explicitly visible in FIG. 1). The cache line thread identifier 124 and, if used, address space identifier, virtual tag and mode bits, can be configured, for example, according to known, conventional techniques.

In an aspect, the thread share permission tag 126 can be switchable from a “not shared” state to one or more “share permission” states. In an aspect, thread share permission tag 126 may be configured with a quantity of bits. The quantity can establish or bound the quantity of concurrent threads that can share a resident cache line 120. For example, if a design goal is up to two threads can share resident cache lines 120, the thread share permission tag 126 can be a single bit (not explicitly visible in FIG. 1). The single bit can be switched between a first logical state (e.g., logical “0”) that indicates the resident cache line 120 is not shared, and a second logical state (e.g., logical “1”) that indicates the other of the two threads has sharing permission to that resident cache line 120.

Table I below shows one example of single-bit configuration for thread share permission tag 126.

TABLE I

| Thread Share | |
|---|---|
| Permission Tag | Resident Cache Line Thread ID |

| 126 | First Thread ID | Second Thread ID |
|---|---|---|
| 0 | Line Not Shared | Line Not Shared |
| 1 | 2^{nd} Thread Share | 1^{st} Thread Share |

Referring to Table I, in an aspect the correspondence or mapping of the thread share permission tag 126 to which other thread(s) have thread share permission can depend on the resident cache line thread ID. For example, if the resident cache line thread ID is a first thread ID, the bit value “1” for the thread share permission tag 126 can indicate the second thread having thread share permission to that resident cache line. The example resident cache line having the first thread ID as its resident cache line thread ID can be a second thread shared resident cache line, and the bit value “1” can be a second thread shared permission state for the thread share permission tag 126. If the resident cache line thread ID is a second thread ID, the same bit value “1” for the thread share permission tag 126 can indicate the first thread having thread share permission to that resident cache line. The example resident cache line having the second thread ID as its resident cache line thread ID can be a first thread shared resident cache line, and the bit value “1” can be a first thread shared permission state for the thread share permission tag 126.

The thread share permission tag 126 may, in one alternative aspect, be configured with two or more bits (not explicitly visible in FIG. 1). Table II below shows one example of such a configuration thread share permission tag 126m comprising, having a first bit, which can be arbitrarily set as the rightmost bit, and a second bit, which can arbitrarily set as the leftmost bit. The first bit and the second bit, being two bits, can enable resident cache lines 120 to be shared by three threads. The three threads are the thread that instantiated the resident cache line 120 (which is indicted by the resident cache line thread ID), and either one or both of the other two threads.

TABLE II

| Thread Share | | | |
|---|---|---|---|
| Permission Tag | Resident Cache Line Thread ID | | |
| 126 | First Thread ID | Second Thread ID | Third Thread ID |
| 00 | Line Not | Line Not | Line Not |
| | Shared | Shared | shared |
| 01 | 2^{nd} Thread | 1^{st} Thread | 1^{st} Thread |
| | Share | Share | Share |
| 10 | 3^{rd} Thread | 3^{rd} Thread | 2^{nd} Thread |
| | Share | Share | Share |
| 11 | 2^{nd}, 3^{rd} Thread | 1^{st}, 3^{rd} Thread | 1^{st}, 2^{nd} Thread |
| | Share | Share | Share |

Referring to Table II, in an aspect, the correspondence or mapping of the thread share permission tag 126 to which other thread(s) have thread share permission can depend on the resident cache line thread ID. For example, if the resident cache line thread ID is a first thread ID, the bit values “01” for the thread share permission tag 126 can indicate the second thread has thread share permission to that resident cache line. If the resident cache line thread ID is a second thread ID, the same bit values “01” for the thread share permission tag 126 can indicate the first thread has thread share permission to that resident cache line. If the resident cache line thread ID is a first thread ID, the bit values “11” for the thread share permission tag 126 can indicate the second thread and the third thread have thread share permission to that resident cache line. If the resident cache line thread ID is a second thread ID, though, the same bit values “11” for the thread share permission tag 126 can indicate the first thread and the third thread have thread share permission to that resident cache line. The example resident cache line having the second thread ID can then be a first thread-third thread shared resident cache line, and the “11” value of the thread share permission tag 126 can be a first thread-third thread permission state.

The Table II definitions are only one example, and do not limit the scope of any aspect. On the contrary, upon reading this disclosure, persons of skill can identify various alternative two-bit configurations of the thread share permission tag 126 that can provide equivalent functionality. Such persons can also extend concepts illustrated by Table II to a three or more bit configuration of the thread share permission tag 126, without undue experimentation.

Referring to FIG. 1, in an aspect, the cache fill buffer 116 can be configured to receive a cache fill line 128. Referring to the enlarged area labeled “CX,” the cache fill line 128 may include an index 130 (labeled “RVI” in FIG. 1), cache fill line data 134, and may be tagged with a cache fill line thread identifier 132 (labeled “CTI” in FIG. 1). In an aspect, the cache fill line 128 may also include a cache fill line virtual tag 135 (labeled in FIG. 1 as “CVT”). The cache fill line 128 may be received, for example, following a cache miss for a cache read of the cache fill line 128 by the thread identified by the cache fill line thread identifier 132. The cache fill line 128 may be received, for example, over a logical path 129 between the dynamic thread permission tagged cache device 114 and the second level cache 112. Means for generating the cache fill line 128, and the format and configuration of the cache fill line 128, its index 130, cache fill line thread identifier 132 and cache fill line data 134, can be according to known, conventional cache line fill techniques. Therefore, except where incidental to description of example aspects or operations according to same, further detailed description of generating the cache fill line 128 is omitted.

In an aspect, the cache control logic 118 can comprise probe logic 136 (labeled “PB Logic” in FIG. 1), cache line data compare logic 138 (labeled “CMP Logic” in FIG. 1), and thread share permission tag update logic 140 (labeled “TSP Tag Logic” in FIG. 1). The probe logic 136 may be configured to perform, upon or in response to the cache fill buffer 116 receiving and temporarily holding the cache fill line 128, operations of probing the dynamic thread permission tagged cache device 114, using the index 130 of the cache fill line 128 and all thread identifiers other than the cache fill line thread identifier 132. In an aspect, the probing can determine, for each of the other thread identifiers, whether the dynamic thread permission tagged cache device 114 holds, associated with the index 130 of the cache fill line 128 in the cache fill buffer 116, a resident cache line 120 that is valid. For convenient reference in describing example operations, valid resident cache lines (if any) found by the probe operations will be referred to as “potential duplicate cache lines” (not separately labeled on FIG. 1).

In an aspect, the cache line data compare logic 138 can be configured to perform, for each (if any) potential duplicate cache line, a comparison of its resident cache line data 122 to the cache fill line data 134 of the cache fill line 128 being held in the cache fill buffer 116. The cache line data compare logic 138 can also be configured, in an aspect, to identify any potential duplicate cache line as a “duplicated cache line” (not separately labeled on FIG. 1) in response to determining that the resident cache line data 122 of that potential duplicate cache line matching the cache fill line data 134. In an aspect, the thread share permission tag update logic 140 can be configured to update the thread share permission tag 126 of the duplicated cache line to a permission state that indicates the thread corresponding to the cache fill line thread identifier 132 has permission to access the duplicated cache line.

Referring to FIG. 1, in an aspect, the cache control logic 118 can be further configured, in an aspect, to discard the cache fill line 128 upon determining existence of the duplicated cache line, as will be described in greater detail later.

In addition, in an aspect, the cache control logic 118 can be configured such that, upon at least two events, it loads the cache fill line 128 into the dynamic thread permission tagged cache device 114 as a new resident cache line (not separately labeled in FIG. 1). One of the two events can be the probe logic 136 not finding a potential duplicate cache line. The probe logic 136 can be configured to generate, upon not finding a potential duplicate cache line, an indication of non-existence of a potential duplicate cache line. The other of the at least two events can be the cache line data compare logic 138 finding the cache fill line data 134 not matching the resident cache line data 122 of the potential duplicate cache line. The thread share permission tag update logic 140, in an aspect, can be configured such that the thread share permission tag 126 of the new resident cache line is initialized to a “not shared” state. Except for the initialization of the thread share permission tag, the loading of the new resident cache line can be in accordance with known, conventional techniques of loading a new resident cache line and, therefore, further detailed description is omitted. Regarding the cache fill line data 134 not matching the resident cache line data 122 of the potential duplicate cache line, in an aspect, the cache control logic 118 can be configured to maintain the thread share permission tag of the potential duplicate resident cache line in the not shared state, in association with loading the new resident cache line. In other words, the cache control logic 118 can be one example of a means for setting a thread share permission tag of the new resident cache line to the not shared state, in association with loading the new resident cache line in the cache 106. In an aspect, the cache control logic 118 can also be an example of a means for loading a new resident cache line in the cache 106, the new resident cache line comprising the cache fill line data and the first thread identifier, in response to an indication, based on a result of probing the cache address, the result indicating a non-existence of the potential duplicate resident cache line.

Referring to FIG. 1, the processor system 100 is shown configured with the cache 106 as a first level cache, logically separated from the processor main memory 110 by a second level cache 112. It will be understood that this is only for purposes of example, and is not intended to limit the scope of practices according to any aspect. Contemplated practices include, for example, a single level cache arrangement (not explicitly visible in FIG. 1), using the cache 106, or comparably featured dynamic MTS permission tag cache according to one or more aspects, logically arranged between the CPU 102 and the processor main memory 110. Contemplated practices also include a three or more level cache, for example, a configuration similar to the processor system 100, but having another cache (not explicitly visible in FIG. 1) arranged between the second level cache 112 and the processor main memory 110, or between the CPU 102 and the cache 106, or both.

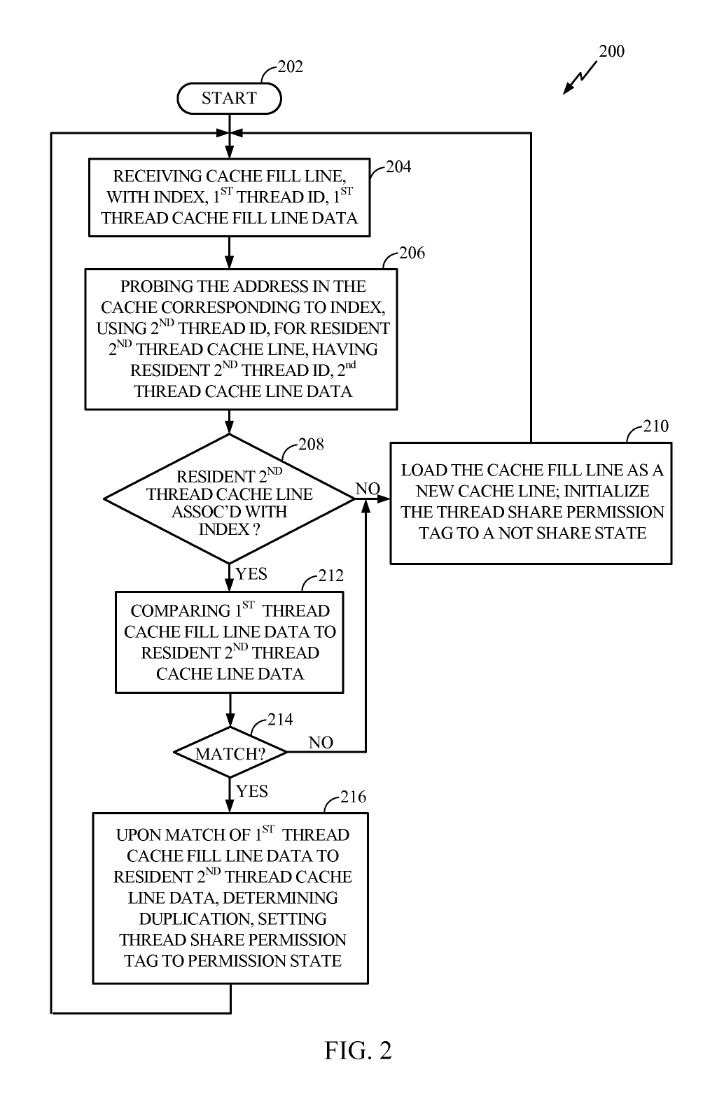

FIG. 2 shows a flow 200 of example operations within one example dynamic MTS permission tag cache process according to various exemplary aspects. Aspects will be described in reference to FIG. 1. This is only for convenient reference to example practices of the operations, and is not intended to limit implementations or environments to the FIG. 1. The flow 200 can start at an arbitrary starting point 202, for example, normal operations of the CPU 102 executing a program. The instructions for the program may be stored, for example, in the processor main memory 110. It will be assumed that copies of portions of the instructions have already been loaded (e.g., due to initial cache misses), as resident cache lines 120 in the dynamic thread permission tagged cache device 114. It will be assumed that the program includes a first thread and second thread, with each accessing the cache 106. There may be additional threads, but description is omitted because persons of skill, upon reading this disclosure, can readily apply the described concepts to three and more threads, without undue experimentation. To focus description, initially, on aspects of switching the thread share permission tag 126 from a “not shared” state to a shared permission state, example operations assume the thread share permission tag 126 for resident cache lines 120 are at the “not shared” state, e.g., logical “0.”

Referring to FIG. 2, operations can begin at 204 with receiving a cache fill line, comprising an index, a first thread identifier, and cache fill line data, in association with a cache miss by the first thread. Referring to FIG. 1, one example of operations at 204 may include receiving the cache fill line 128, with the index 130, cache fill line thread identifier 132, and cache fill line data 134. Referring to FIG. 2, after operations at 204 the flow 200 can proceed to 206, and apply operations of probing a cache address, the cache address corresponding to the cache fill line index, using a second thread identifier. The operations at 206 of probing the cache address can determine if there is a resident cache line corresponding to the cache fill line index, tagged with the second thread identifier and including resident cache line data. Referring to FIG. 1, one example of operations at 206 can include the probe logic 136, in response to receiving the cache fill line 128 that is tagged with the first thread identifier as its cache fill line thread identifier 132, probing the dynamic thread permission tagged cache device 114, using the second thread identifier. In the labeling in flow block 206, resident cache lines 120 tagged with the second thread identifier are labeled as “resident 2^{ND} thread cache lines” (a label not separately appearing in FIG. 1).

Referring to FIG. 2, upon completion of the probing operations at 206 the flow 200 can proceed to decision block 208. As shown by the “NO” branch of decision block 208, if operations at 206 do not find a resident second cache line associated with the cache fill line index, the flow 200 can proceed to 210 and apply operations of loading the cache fill line received at 204 into the cache as a resident new resident cache line. Operations at 210 can include resetting or initializing the thread share permission tag of the new resident cache line to the “not shared” state. After 210 the flow 200 can return to the input to 204 and wait for a next cache miss and resulting cache fill line. The return from 210 to the input to 204 can include a repeating of the first thread access (not explicitly visible in FIG. 2) that produced the earlier first thread cache miss resulting in the first thread cache fill line received at 204. Operations of repeating the first thread cache access can be according to known, conventional techniques and, therefore, further detailed description is omitted.

Referring to FIG. 1, one example of operations at 210 can include the cache control logic 118 initiating loading a new resident cache line in the dynamic thread permission tagged cache device 114, the new resident cache line comprising the first thread cache fill line data and the first thread identifier.

In an aspect, as shown by the “YES” branch of decision block 208, if operations at 206 determine there is a resident second thread cache line associated with the cache ill line index, the flow 200 can proceed to 212. The resident cache line (if any) identified at 206 can be referred to, as described above, as the “potential duplicate cache line.” At 212 operations can include comparing the cache fill line data received at 204 to the resident cache line data of the potential duplicate cache line. As shown by the “YES” branch of decision block 214, upon a match of the cache fill line data to the resident cache line data of the potential duplicate cache line, the flow 200 can proceed to 216, determine a duplication, and apply operations of setting a thread share permission tag of the resident cache line to a permission state, the permission state indicating the first thread has sharing permission to the resident cache line.

Referring to FIG. 2, as shown by the “NO” branch of decision block 214, if the comparing at 212 determines do not find a resident second cache line associated with the cache fill line index, the flow 200 can proceed to 210, as described above, and return to the input of 204.

The cache control logic 118, as described above in performing operations in relation to the FIG. 2 flow 200, provides one example of means for loading a new resident cache line in the cache 106, the new resident cache line comprising the cache fill line data and the first thread identifier, in response to an indication, based on a result of probing the cache address, the result indicating a non-existence of the potential duplicate resident cache line.

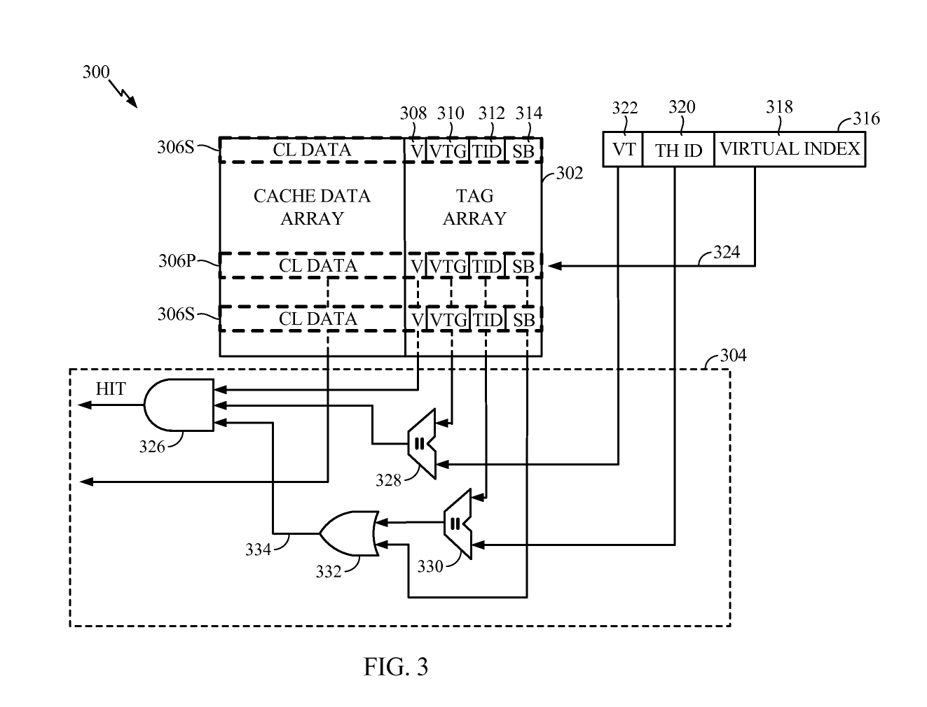

FIG. 3 shows a logic schematic of a dynamic thread sharing cache 300 according to various aspects. The dynamic thread sharing cache 300 may implement, for example, the FIG. 1 dynamic thread permission tagged cache device 114. Referring to FIG. 3, the dynamic thread sharing cache 300 can include thread permission tagged cache memory 302, and permission tagged access circuit 304. The thread permission tagged cache memory 302 can be configured as a virtual tag/virtual index (VIVT) device. Other than multi-thread dynamic cache line permission tag functionality according to disclosed concepts and aspects of same, the thread permission tagged cache memory 302 can be configured and implemented according to known, conventional associative VIVT cache techniques. The thread permission tagged cache memory 302 can store a plurality of cache lines such as the three cache lines shown in FIG. 3, one of which is labeled with the reference number “306P” and the other two are labeled with the reference number 306S.” For convenience, the cache lines in FIG. 3 can be collectively referenced as “cache lines 306” (a label not separately visible in FIG. 3), The cache lines 306 can be according to the resident cache lines 120 described in reference to FIG. 1. The cache lines 306 can therefore be configured as MTS permission tagged cache lines, having functionality and configuration such as the described resident cache lines 120.

Each cache line 306 can include a cache line tag (visible but not separately labeled) that, in turn, can include a cache line validity flag 308 (labeled “V” in FIG. 3), a cache line virtual tag 310 (labeled “VTG” in FIG. 3), a cache line thread identifier 312 (labeled “TID” in FIG. 3), and a cache line thread share permission tag 314 (labeled “SB” in FIG. 3). The cache line thread share permission tag 314 is described in greater detail later. The cache line thread identifier 312 and cache line thread share permission tag 314 can be, respectively, example implementations of the FIG. 1 cache line thread identifier 124 and thread share permission tag 126. In an aspect, the cache line validity flag 308, cache line virtual tag 310, and cache line thread identifier 312 can be configured according to known, conventional cache line validity flag, cache line virtual tag, and cache line thread identifier techniques and, therefore, further detailed description is omitted except where incidental to the description of example operations and features.

The dynamic thread sharing cache 300 can be configured to receive a cache read request 316. In an aspect, the cache read request 316 can be generated and formatted, for example, according to known, conventional virtual address fetch techniques, by the FIG. 1 CPU 102, or another conventional processor in an environment that includes a main memory and a cache storing copies of portions of the main memory. The cache read request 316 can include, in addition to the read request virtual index 318, a cache read request thread identifier 320 (labeled “TH ID” in FIG. 3), and a read request virtual tag 322 (labeled “VT” in FIG. 3). The read request virtual index 318 and cache read request thread identifier 320 can be, respectively, implementations of the FIG. 1 cache fill line thread identifier 132 and the cache fill line virtual tag 135. In an aspect, the read request virtual index 318 and the cache read request thread identifier 320 can be configured according to known, conventional multi-thread virtual address read techniques and, therefore, further detailed description is omitted except where incidental to the description of example operations and features

Referring to FIG. 3, the dynamic thread sharing cache 300 may include means (not explicitly visible in FIG. 3) for storing each cache line 306 in a respective location in the thread permission tagged cache memory 302 that corresponds to a virtual index (not explicitly visible in FIG. 3) of a cache fill request (not explicitly visible in FIG. 3) that loaded it. The dynamic thread sharing cache 300 may include similar means (not explicitly visible in FIG. 3) for searching the thread permission tagged cache memory 302, in response to the cache read request 316, for determining whether there is a valid cache line 306 at a location corresponding to the read request virtual index 318. The means for storing each cache line 306 in a respective location in the thread permission tagged cache memory 302. The means for searching the thread permission tagged cache memory 302 can be according to known, conventional index-base decoding, loading and read techniques that known to persons of skill. Further detailed description is therefore omitted except where incidental to description of features, implementations and operations according to aspects.

As described for the thread share permission tag 126, the cache line thread share permission tag 314 may be switchable between a “not shared” state, and one or more share permission states (not explicitly visible in FIG. 3). As described above, a quantity of bits in the cache line thread share permission tag 314 determines, or at least limits the quantity of threads that can share a cache line 306. Means for determining the state of the cache line thread share permission tag 314 can be structured based, in part, on the quantity of its constituent bits. As one illustrative example, if the cache line thread share permission tag 314 is one bit, the bit state itself can be a means for determining whether a cache read request 316, having cache read request thread identifier 320 different from the cache line thread identifier 312 of a given cache line 306, has thread share permission to access that cache line 306. Accordingly, assuming a one-bit configuration of the cache line thread share permission tag 314, a means for determining whether the cache read request 316, having a cache read request thread identifier 320 different from the cache line thread identifier 312 of a given cache line 306, has thread share permission to access that cache line 306.

Referring to FIG. 3 the permission tagged access circuit 304 may include virtual tag comparator 328. The virtual tag comparator 328 can be one example means for determining that the read request virtual tag 322 matches the cache line virtual tag 310. The virtual tag comparator 328 can be configured in accordance with known, conventional VIVT virtual tag comparing techniques and, therefore, further detailed description is omitted.

In an aspect, the permission tagged access circuit 304 may include thread identifier comparator 330. The thread identifier comparator 330 can be one example means for determining that the cache read request thread identifier 320 matches the cache line thread identifier 312. The thread identifier comparator 330 can be configured in accordance with known, conventional VIVT thread identifier comparing techniques and, therefore, further detailed description is omitted.

Referring to FIG. 3, the permission tagged access circuit 304 may include two-input logical OR gate 332. The two-input logical OR gate 332 can receive, as a first input, the output of the thread identifier comparator 330. The two-input logical OR gate 332 can receive, as a second input, the cache line thread share permission tag 314 from whichever (if any) of the cache lines 306 is stored, in the dynamic thread sharing cache 300, at a location corresponding to the read request virtual index 318 of a given cache read request 316. Accordingly, two events can produce an affirmative logical output 334 from the two-input logical OR gate 332. One is an affirmative logical output from the thread identifier comparator 330. The other is the cache line thread share permission tag 314 being in a share permission state (e.g., a logical “1”). Accordingly, there are two scenarios that can place all three inputs of the three-input logical AND gate into a logical “1” state. Both scenarios require a valid cache line 306 in the dynamic thread sharing cache 300, at a location corresponding to the read request virtual index 318. For convenient referencing in describing example operations, this can be referred to as a “potential hit cache line” (a label not separately appearing in FIG. 3). The first scenario is the cache read request thread identifier 320 matching the cache line thread identifier 312 of the potential hit cache line. The second is the cache line thread share permission tag 314 of the potential hit cache line being in a thread share permission state (e.g., a logical “1).

Referring to FIGS. 1 and 2, example operations in another process according to aspects will be described. The example assumes a process according to the flow 200, with three threads running. The threads will be referenced as a “first thread,” “second thread,” and “third thread.” The example assumes a cache first fill line, according to the cache fill line 128, caused detection of duplication with a resident cache line. The duplication will be referred to as a “first duplication.” The cache fill line thread identifier 132 of the cache first fill line is assumed to be of a first thread, and is therefore referred to as a “first thread identifier.” The resident cache line associated with detection of the first duplication will be referred to as a “first resident cache line.” It will be assumed that the first resident cache line was loaded by the second thread. It will also be assumed that, in response to detection of the first duplication, a process according to the flow 200 set the thread share permission tag 126 of the first resident cache line at a first thread permission state. The described first resident cache line will therefore be referred to as a “first thread shared resident cache line.”

Continuing with the example, operations can include receiving a cache second fill line, at the cache fill buffer 116, configured according to the cache fill line 128. The cache fill line thread identifier 132 of the cache second fill line will be assumed, for purposes of example, to be of the third thread. This value of the cache fill line thread identifier 132 will be referred to as a “third thread identifier.” The cache second fill line will be assumed to include an index, e.g., the index 130, a cache second fill line data, such as the cache fill line data 134. The cache second fill line data may have been retrieved, for example, in association with a cache miss by the third thread. It will be assumed, for purposes of this example, that the index of the cache second fill line maps to the first thread shared resident cache line described above. In an aspect, operations in a process according to the flow 200 can then determine if the cache second fill line data matches the resident cache line data of the first thread shared resident cache line. If a match is detected, there is a second duplication, of the same resident cache line. In an aspect, upon determining the second duplication, operations can perform another or second deduplication.

In an aspect, the second deduplication can include setting or assigning the first thread shared resident cache line to be further shared by the third thread. The setting or assigning can include setting the thread share permission tag, previously set to a first thread permission state, to a first thread-third thread permission state. Referring to Table II, middle column, an example of setting the thread share permission tag, previously set to a first thread permission state, to a first thread-third thread permission state, can be the transition from the middle row to the last row, middle column, i.e., switching the thread share permission tag 126 from “01” to the “11” state. The “11” This sets or assigns the above-described example first thread shared resident cache line to be a first thread-third thread shared resident cache line.

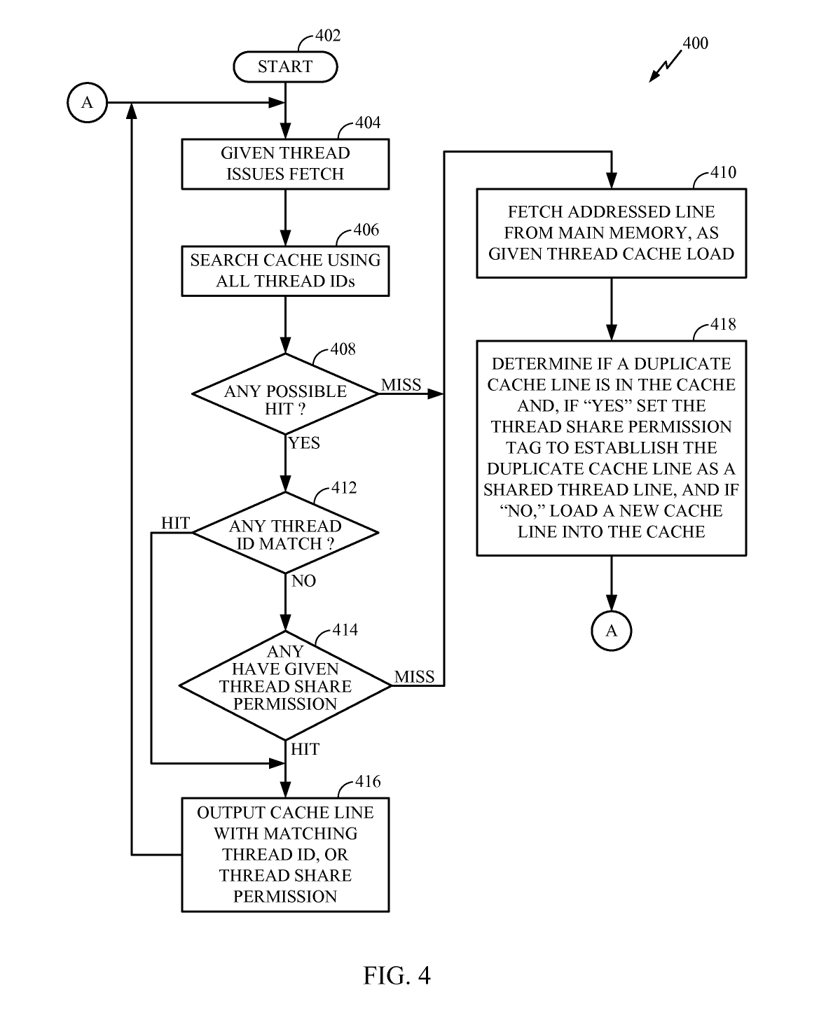

FIG. 4 shows a flow 400 of example operations in a read/thread share permission tag update process according to various aspects. The flow 400 basically combines features represented by the flow 200 with multi-thread read features provided by the dynamic thread sharing cache 300. The flow 400 can start at an arbitrary start 402, and then proceed to 404, where a given thread issues a fetch. Example operations at 404 can be the FIG. 1 CPU 102 issuing a memory fetch request (not explicitly visible in FIG. 1), comprising a virtual address (not explicitly visible in FIG. 1) and a given thread ID. Assuming the fetch request is according to a virtual address/vertical tagged addressing scheme, the flow 400 can then proceed to 406 and perform a searching of a particularly configured cache memory device, for example, the FIG. 1 dynamic thread permission tagged cache device 114, or the FIG. 3 dynamic thread sharing cache 300. In an aspect, the searching at 406 can differ from known, conventional techniques for searching thread-identifier tagged cache lines. More specifically, in conventional techniques for searching thread-identifier tagged cache lines, the search can use only the thread identifier that is the thread identifier tag of the cache search request. The searching at 406, in contrast, can search each of a given or established set of thread identifiers

Referring to FIG. 4, if the search at 406 finds no possible hits, the decision block 408 detects a miss and the flow 400 proceeds to 410, which is described in greater detail later. If the search at 406 finds at least one possible hit, the flow 400 proceeds from the decision block at 408 to 412, where operations are applied to determine if any of the possible hits has a thread ID matching the thread ID of the fetch that issued at 404. If the answer at 412 is YES, the possible hit having the matching thread ID is an actual hit, whereupon the flow 400 proceeds to 414 and outputs the resident cache line data of that hit. Referring to FIG. 3, an example means for determining at 412 is a read request virtual index 318 that maps, as shown by logical arrow 324, to a matching cache line 306P, in combination with the virtual tag comparator 328 and a cache line thread identifier 312. The concurrence of the three conditions places all “1s” at the input of the three-input logical AND gate 326.

Referring to FIG. 4, if operations at 412 find none of the possible hits has a thread ID matching the thread ID of the fetch issued at 404, the flow 400 proceeds to 416 to determine if any of the possible hits has a thread share permission tag at a state indicating the given thread (corresponding to the cache read request thread identifier 320) has share permission. If the answer is YES, as indicated by the “HIT” branch from 414, an actual hit is detected. In response the flow 400 proceeds to 414 and outputs the resident cache line data of that hit and returns to 404.

Referring to FIGS. 3 and 4 together, it will be understood that the above-described operations at 408, 412, and 414 can be performed in parallel, namely by the FIG. 3 virtual tag comparator 328, thread identifier comparator 338, two-input logical OR gate 332 and three-input logical AND gate 326.

Referring to FIGS. 1 and 4, one example of operations at 402 through 412 will be described assuming that at least a first thread and a second thread are running, and that the second thread has loaded one of the resident cache lines 120. It will also be assumed that the resident cache line is a shared resident cache line, with its thread share permission tag set to a permission state that gives the first thread sharing permission. The example of operations can comprise, subsequent to setting the thread share permission tag to the permission state that gives the first thread sharing permission, attempting to access the cache with a cache read request from the first thread. The attempt can include a cache read request from the first thread, the cache read request comprising the index of the particular resident cache line 120 and the first thread identifier. Operations can then include, based at least in part on the permission state of the thread share permission tag indicating the first thread has sharing permission, retrieving at least the resident cache line data of the shared resident cache line.

Referring to FIG. 4 and continuing with description of the flow 400, if the operations at 408 or 416 detect a miss, the flow 400 can proceed to 410. Operations at 418 are applied retrieve the desired cache line from the processor main memory 110.

The operations at 418 can be according to known conventional search of a main memory in response to a cache miss and, therefore further detailed description is omitted. Assuming the operations at 418 find the desired cache line, the flow 400 can proceed to 420 and apply a process according to the flow 200. The operations can, as described above, determine if a duplicate cache line is in the cache and, if “YES, set the thread share permission tag of that duplicate cache line to a thread share permission state, else load the cache line received at 410. Operations, and implementations of same, can be according to the flow 200 and its example implementations that are described above.

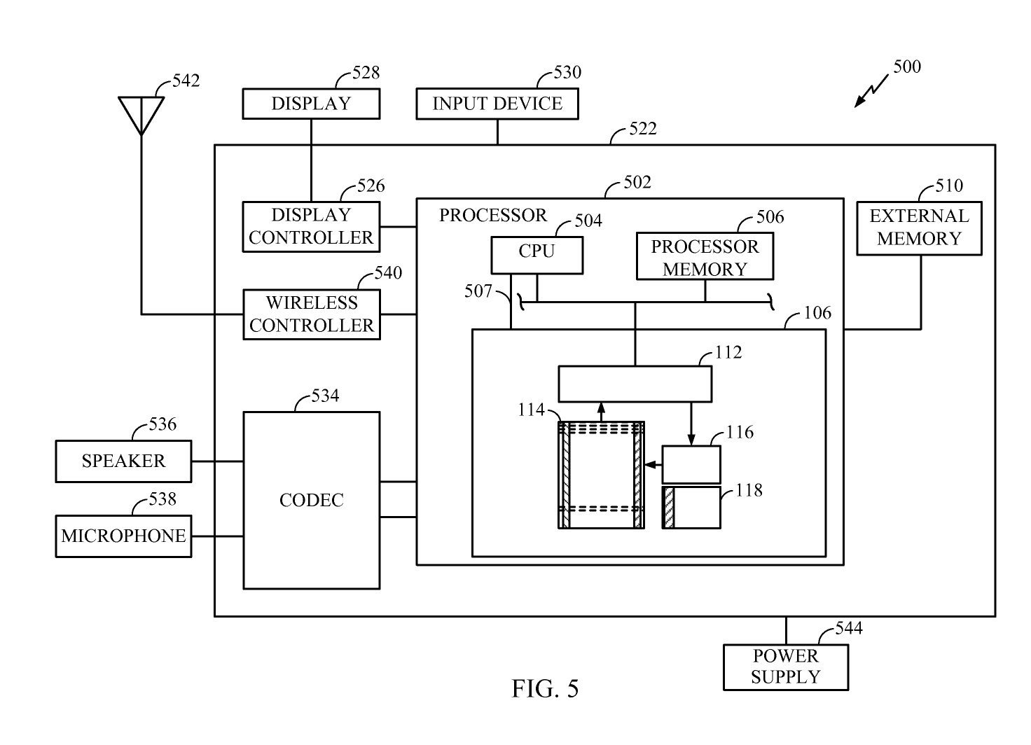

FIG. 5 illustrates a wireless device 500 in which one or more aspects of the disclosure may be advantageously employed. Referring now to FIG. 5, wireless device 500 includes processor 502 having a CPU 504, a processor memory 506 and cache 106. The CPU 504 may generate virtual addresses to access the processor memory 506 or the external memory 510. The virtual addresses may be communicated, over the dedicated local coupling 507, to the cache 106 for example, as described in reference to FIG. 4.

Wireless device 500 may be configured to perform the various methods described in reference to FIGS. 2 and 4, and may be further be configured to execute instructions retrieved from processor memory 506, or external memory 510 in order to perform any of the methods described in reference to FIGS. 2 and 4.

FIG. 5 also shows display controller 526 that is coupled to processor 502 and to display 528. Coder/decoder (CODEC) 534 (e.g., an audio and/or voice CODEC) can be coupled to processor 502. Other components, such as wireless controller 540 (which may include a modem) are also illustrated. For example, speaker 536 and microphone 538 can be coupled to CODEC 534. FIG. 5 also shows that wireless controller 540 can be coupled to wireless antenna 542. In a particular aspect, processor 502, display controller 526, processor memory 506, external memory 510, CODEC 534, and wireless controller 540 may be included in a system-in-package or system-on-chip device 522.

In a particular aspect, input device 530 and power supply 544 can be coupled to the system-on-chip device 522. Moreover, in a particular aspect, as illustrated in FIG. 5, display 528, input device 530, speaker 536, microphone 538, wireless antenna 542, and power supply 544 are external to the system-on-chip device 522. However, each of display 528, input device 530, speaker 536, microphone 538, wireless antenna 542, and power supply 544 can be coupled to a component of the system-on-chip device 522, such as an interface or a controller. It will be understood that the cache 106 may be part of the processor 502.

It should also be noted that although FIG. 5 depicts a wireless communications device, processor 502 may also be integrated into a set-top box, a music player, a video player, an entertainment unit, a navigation device, a personal digital assistant (PDA), a fixed location data unit, a computer, a laptop, a tablet, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, implementations and practices according to the disclosed aspects can include a computer readable media embodying a method for de-duplication of a cache. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for de-duplication of a cache, comprising:
receiving a cache fill line, comprising an index, a first thread identifier, and cache fill line data;
probing a cache address, the cache address corresponding to the index, using a second thread identifier, for a potential duplicate resident cache line, including resident cache line data and tagged with the second thread identifier;
based at least in part on a match of the cache fill line data to the resident cache line data, determining a duplication; and
in response to determining the duplication, assigning the potential duplicate resident cache line as a shared resident cache line and setting a thread share permission tag of the shared resident cache line to a permission state, the permission state indicating a first thread has sharing permission to the shared resident cache line.

2. The method of claim 1, further comprising, in response to a result of the probing being an indication of non-existence of the potential duplicate resident cache line, loading a new resident cache line, the new resident cache line being in the cache, and comprising the cache fill line data and the first thread identifier.

3. The method of claim 2, the thread share permission tag of the potential duplicate resident cache line being switchable between a not shared state and the permission state, the method further comprising: in association with loading the new resident cache line, setting a thread share permission tag of the new resident cache line to the not shared state.

4. The method of claim 3, further comprising cache resetting, the cache resetting including a switching of the thread share permission tag to the not shared state.

5. The method of claim 2, further comprising: in response to a result of the probing identifying the potential duplicate resident cache line, in combination with the cache fill line data not matching the resident cache line data, loading the new resident cache line in the cache.

6. The method of claim 5, the potential duplicate resident cache line including the thread share permission tag, the thread share permission tag being in a not shared state, the method further comprising, in association with loading the new resident cache line in the cache, maintaining the thread share permission tag of the potential duplicate resident cache line in the not shared state.

7. The method of claim 1, the duplication being a first duplication, the cache fill line being a cache first fill line, the shared resident cache line being a first thread shared resident cache line, and the permission state being a first thread permission state, the method further comprising:
receiving a cache second fill line, comprising the index, a third thread identifier, the third thread identifier being associated with a third thread, and a cache second fill line data, in association with a cache miss by a third thread;
based at least in part on a match of the cache second fill line data to the resident cache line data of the first thread shared resident cache line, determining a second duplication; and
upon determining the second duplication, assigning the first thread shared resident cache line as a first thread-third thread shared resident cache line, and setting a thread share permission tag of the first thread-third thread shared resident cache line to a first thread-third thread permission state, the first thread-third thread permission state being configured to indicate the first thread and the third thread have sharing permission to the first thread-third thread shared resident cache line.

8. The method of claim 1, wherein setting the thread share permission tag of the shared resident cache line to the permission state comprises switching the thread share permission tag of the shared resident cache line from a not shared state to the permission state.

9. The method of claim 8, further comprising:
after setting the thread share permission tag to the permission state, attempting to access the cache with a cache read request from the first thread, the cache read request from the first thread comprising the index and the first thread identifier and, in response, based at least in part on the permission state of the thread share permission tag, retrieving at least the resident cache line data of the shared resident cache line.

10. The method of claim 1, further comprising:
resetting the thread share permission tag of the shared resident cache line to the not shared state
attempting to access the cache with a cache read request from the first thread, the cache read request from the first thread comprising the index and the first thread identifier; and
indicating a miss, based at least in part on a combination of the first thread identifier not matching the second thread identifier, and the not shared state of the thread share permission tag.

11. The method of claim 1, the thread share permission tag comprising a bit, the permission state being a logical “1” value of the bit, and the not shared state being a logical “0” value of the bit.

12. The method of claim 11, the bit being a first bit, the thread share permission tag further comprising a second bit, the not shared state being a logical value of “0” for the first bit in combination with a logical value of “0” for the second bit.

13. A cache system, comprising:
a cache, configured to retrievably store a plurality of resident cache lines, each at a location corresponding to an index, and each including resident cache line data, and tagged with a resident cache line thread identifier and a thread share permission tag;
a cache line fill buffer, configured to receive a cache fill line, comprising a cache fill line index, a cache fill line thread identifier and cache fill line data; and
a cache control logic, configured to
identify, in response to the cache fill line thread identifier being a first thread identifier, a potential duplicate cache line, the potential duplicate cache line being among the resident cache lines and being tagged with a second thread identifier, and
set the thread share permission tag of the potential duplicate cache line to a permission state, based at least in part on the potential duplicate cache line in combination with a matching of a cache line data of the potential duplicate cache line to the cache fill line data.

14. The cache system of claim 13, the cache control logic being further configured, in order to identify the potential duplicate cache line, to
probe a cache address, the cache address corresponding to the cache fill line index, and upon a result of the probe identifying the potential duplicate cache line, to compare resident cache line data of the potential duplicate cache line to the cache fill line data and to determine the matching of the potential duplicate cache line data to the cache fill line data based, at least in part, on a result of the compare.

15. The cache system of claim 14, the cache control logic comprising:
probe logic; and
cache line data compare logic,
the probe logic being configured to perform operations of probing the cache using the second thread identifier, upon or in response to receiving the cache fill line, and
the cache line data compare logic being configured to compare the resident cache line data of the potential duplicate cache line to the cache fill line data.

16. The cache system of claim 15, the cache control logic further comprising
thread share permission tag update logic, the thread share permission tag update logic being configured to set the thread share permission tag of the potential duplicate cache line to the permission state.

17. The cache system of claim 16, the thread share permission tag update logic being further configured to set the thread share permission tag of the potential duplicate cache line to the permission state by switching the thread share permission tag of the potential duplicate cache line from a not shared state to the permission state.

18. The cache system of claim 13, the cache control logic being further configured to load, into the cache, a new resident cache line, in response to a match of a cache line data of the potential duplicate cache line to the cache fill line data, the new resident cache line comprising the cache fill line thread identifier and the cache fill line data, and to load the new resident cache line at an address corresponding to the cache fill line index.

19. The cache system of claim 18, the cache control logic being further configured to set the thread share permission tag of the new resident cache line to a not shared state.

20. The cache system of claim 19, a thread share permission tag of the potential duplicate resident cache line being in the not shared state, the cache control logic being further configured to maintain the thread share permission tag of the potential duplicate resident cache line in the not shared state in association with loading the new resident cache line.

21. The cache system of claim 20, the thread share permission tag comprising a bit, the permission state being a logical “1” value of the bit, and the not shared state being a logical “0” value of the bit.

22. The cache system of claim 14, the thread share permission tag being configured, when set, to indicate the potential duplicate cache line as a shared resident cache line, and the permission state being configured to indicate a first thread has permission to access the shared resident cache line, the cache control logic being further configured to receive a cache read request, subsequent to setting the thread share permission tag to the permission state, the cache read request from the first thread comprising the index and the first thread identifier and, in response, based at least in part on the permission state of the thread share permission tag, retrieving at least the resident cache line data of the shared resident cache line.

23. A system, comprising:
a cache, configured to retrievably store a resident cache line, at an address corresponding to an index, the resident cache line, including resident cache line data and tagged with a first thread identifier and a thread share permission tag, the thread share permission tag at a not shared state and switchable to at least one permission state;
a cache line fill buffer, configured to receive a cache fill line, comprising a cache fill line index and cache fill line data, and tagged with a second thread identifier; and
a cache control logic, configured to
set a thread share permission tag of the resident cache line to a permission state, based at least in part on the cache fill line index being a match to the index, in combination with the resident cache line data being a match the cache fill line data.

24. The system of claim 23, the cache control logic being further configured to load, into the cache, a new resident cache line, in response to the resident cache line data not matching the cache fill line data, the new resident cache line comprising the first thread identifier and the cache fill line data.

25. The system of claim 24, the cache control logic being further configured to set a thread share permission tag of the new resident cache line to the not shared state.

26. The system of claim 25, the cache control logic being further configured to maintain a thread share permission tag of the resident cache line in a not shared state, in association with loading the new resident cache line and the thread share permission tag of the resident cache line being in the not shared state when the cache fill line is received.

27. An apparatus for de-duplication of a cache, comprising
means for receiving a cache fill line, comprising an index and cache fill line data, and tagged with a first thread identifier;
means for probing a cache address, the cache address corresponding to the index, using a second thread identifier, for a potential duplicate resident cache line, the potential duplicate resident cache line comprising resident cache line data and being tagged with the second thread identifier;
means for determining a duplication, based at least in part on a match of the cache fill line data to the resident cache line data; and
means for assigning the potential duplicate resident cache line as a shared resident cache line and setting a thread share permission tag of the shared resident cache line to a permission state, upon determining the duplication, the permission state being configured to indicate a first thread has sharing permission to the shared resident cache line.

28. The apparatus of claim 27, further comprising,
means for loading a new resident cache line in the cache, the new resident cache line comprising the cache fill line data and the first thread identifier, in response to an indication, based on a result of probing the cache address, the result indicating a non-existence of the potential duplicate resident cache line.

29. The apparatus of claim 28, the thread share permission tag of the potential duplicate resident cache line being switchable between a not shared state and the permission state, the apparatus further comprising:
means for setting a thread share permission tag of the new resident cache line to the not shared state, in association with loading the new resident cache line in the cache.

30. The apparatus of claim 29, further comprising means for maintaining the thread share permission tag of the resident cache line in the not shared state in association with loading the new resident cache line in combination with thread share permission tag of the resident cache line being in the not shared state when the cache fill line is received.
